(19) United States
(12) Patent Application Publication
(10) Pub. No.: US 2018/0355993 A1
(43) Pub. Date: Dec. 13, 2018

(54) HYDRAULIC VALVE CONFIGURATION FOR NH VBS WITH A NL SOLENOID

(71) Applicant: Flextronics AP, LLC, San Jose, CA (US)

(72) Inventor: Matthew Peterson, Ada, MI (US)

(73) Assignee: Flextronics AP, LLC, San Jose, CA (US)

(21) Appl. No.: 16/003,769

(22) Filed: Jun. 8, 2018

Related U.S. Application Data
(60) Provisional application No. 62/517,294, filed on Jun. 9, 2017.

(51) Int. Cl. F16K 31/06

(52) U.S. Cl. CPC F16K 31/062; F16K 31/0675

(57) ABSTRACT

A fluid control valve and valve assembly including the fluid control valve are disclosed. The valve includes a valve body comprising a supply port and an exhaust port, each of which are in selective communication with a control port. A valve sealing member is located between a supply valve seat and an exhaust valve seat, and is supported for linear displacement between at least a first valve position and a second valve position. In the first valve position, the valve sealing member is pressed against the exhaust valve seat such that the supply port is in fluid communication with the control port and fluid pressure at the control port is high. In the second valve position, the valve sealing member is pressed against the supply valve seat such that the control port is in fluid communication with the exhaust port and fluid pressure at the control port is low.

### CROSS REFERENCE TO RELATED APPLICATION

This application claims the benefit of U.S. provisional application No. 62/517,294 filed on Jun. 9, 2017, which is incorporated by reference as if fully set forth.

### FIELD OF INVENTION

This application is generally related to fluid control valves, and the fluid control valve assemblies comprising such valves. More particularly, embodiments of the application are related to a three port fluid control valve having two valve seats and a valve sealing member positioned between the two valve seats.

### BACKGROUND

Hydraulic valves may be configured such that a valve sealing member moves relative to a valve seat to selectively allow communication between the various ports, such as between a fluid supply port and a control port, or between an exhaust port and a control port, altering fluid control pressure at the fluid control port. In order to actuate the movement of the valve sealing member, the valve may be coupled to an electromagnetic solenoid.

Hydraulic valves may be in the form of normally high (NH) valves and normally low (NL) valves. In the case of a NH valve, the pressure sensed from a fluid control port is high when the electromagnetic solenoid is not energized. Once the solenoid is energized, current begins to flow and the pressure sensed from the fluid control port decreases and may approach or equal zero fluid pressure. In the case of a NL valve, the pressure sensed from the fluid control port is low to zero when the electromagnetic solenoid is not energized. Once the solenoid is energized, current beings to flow and the pressure sensed from the fluid control port rises.

In order to drive these changes in sensed pressure, a valve sealing member located within the valve body may be actuated by an armature of a solenoid for example, such that the flow of fluid changes between the various ports of the valve. Accordingly, valves may be coupled to either a push-type solenoid or a pull-type solenoid. Depending on which of these solenoid types the valve is connected to, determines whether the valve is acting as a NH valve or as a NL valve.

Currently, the configuration of the valve sealing member and the valve seats within the valve is such that in order to switch the pressure-current relationship of a solenoid valve assembly, the solenoid itself must be changed. For example, a valve coupled to a push-type solenoid having a valve sealing member located on the opposite side of both a supply seat valve and an exhaust seat valve from the solenoid itself, has little to no pressure sensed at the fluid control port in the non-energized state and may be referred to as a NL valve. As the solenoid is energized and current begins to flow, the pressure sensed at the fluid control port increases.

In these solenoid valve assemblies, in order to change the pressure-current relationship, meaning to functionally switch the solenoid valve assembly from one having a NL valve to one having a NH valve such that the sensed fluid pressure at the control port is high when current is zero, the push-type solenoid would have to be exchanged for a pull-type solenoid for example. However, because solenoids are often specifically designed to be incorporated into a specific housing, switching one solenoid component in exchange for another may present complications. For example, the required housing component may not accommodate the other solenoid type or the solenoid may already be part of a sub-assembly within a specific housing.

Accordingly, a need exists for being able to switch the pressure-current relationship of a solenoid valve assembly without the need to switch the solenoid, and instead switch only the valve.

### SUMMARY

Embodiments of a fluid control valve and a fluid control valve assembly are described herein. The valve includes a valve body having at least three ports: a control port; a supply port, which is in selective communication with the control port; and an exhaust port, which is also in selective communication with the control port. The valve body further includes a supply valve seat comprising a supply valve seat orifice, an exhaust valve seat comprising an exhaust valve seat orifice, and an interior chamber between the two valve seats. A valve sealing member is located at least partially within the interior chamber between the two valve seats and is supported for linear displacement between at least a first valve position and a second valve position. In a preferred embodiment, the valve sealing member is a ball.

In the first valve position, the valve sealing member is pressed against the exhaust valve seat, closing the exhaust port from communicating with the supply port and the control port such that the supply port is in fluid communication with the control port. In the second valve position, the valve sealing member is pressed against the supply valve seat, closing the supply port from communicating with the control port and the exhaust port such that the control port is in fluid communication with the exhaust port.

In an embodiment where the valve is coupled with a push-type solenoid, in the non-energized state the valve is in the first valve position. Because fluid pressure sensed from the control port is high in this embodiment in the non-energized state, the valve is referred to as a NH valve. In the energized state, the valve would be in the second position and fluid pressure sensed from the control port would be low.

In another embodiment where the valve is coupled with a pull-type solenoid, in the non-energized state the valve is in the second position. Because fluid pressure sensed form the control port is low in this embodiment in the non-energized state, the valve is referred to as a NL valve. In the energized state, the valve would be in the first position and fluid pressure sensed from the control port would be high.

Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted that the appended drawings illustrate only typical embodiments of this invention and are therefore not to be considered limiting of its scope, for the invention may admit to other equally effective embodiments.

FIG. 1 is a cross-sectional view of a prior art valve coupled with a push-type solenoid in the non-energized state.

FIG. 2A is a cross-sectional view of the valve acting as a normally high (NH) valve, coupled with a push-type solenoid in the non-energized state.

FIG. 2B is an enlarged view of the NH valve of FIG. 2A coupled with the push-type solenoid in the non-energized state.

FIG. 3A is a cross-sectional view of the NH valve coupled with a push-type solenoid in the energized state.

FIG. 3B is an enlarged view of the valve of FIG. 3A coupled with the push-type solenoid in the energized state.

FIG. 4 is a cross-sectional view of the valve acting as a normally low (NL) valve, coupled with a pull-type solenoid.

To facilitate understanding, identical reference numbers have been used where possible to designate identical elements that are common to the figures. It is contemplated that elements and features of one embodiment may be beneficially incorporated in other embodiments without further recitation.

### DETAILED DESCRIPTION OF THE PREFERRED EMBODIMENTS

An inventive valve and valve assembly employing the valve are provided herein.

Certain terminology is used in the following description for convenience only and is not limiting. The words “left” and “right” designate directions in the drawings to which reference is made. The word “proximal” when referring to the valve means a valve element location that is closest to the solenoid. The word “distal” when referring to the valve means a valve element location that is furthest from the solenoid. The word “proximal” when referring to the solenoid or a solenoid element means a solenoid element location that is furthest from the valve, which in the drawings is the right side of the solenoid. The word “distal” when referring to the solenoid or a solenoid element means a solenoid element location that is closest to the valve, which in the drawings is the left side of the solenoid. The word “low” when referring to pressure may mean pressure that is lower that the pressure sensed from the control port in the other valve position having greater pressure, or it may mean zero fluid pressure.

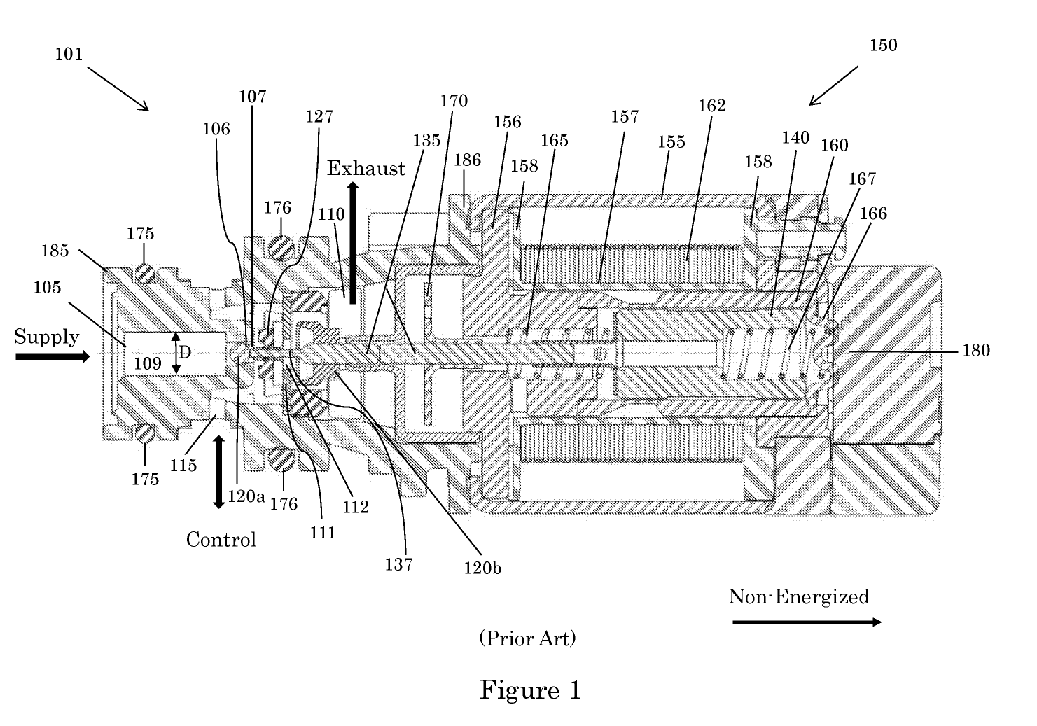

FIG. 1 illustrates a cross-sectional view of a prior art fluid control valve assembly 100 in the non-energized state. The fluid control valve assembly 100 includes a solenoid 150, and a valve 101 comprising a valve body 102 and three ports including; a supply port 105, an exhaust port 110, and a control port 115. Associated with the supply port 105 is a supply valve seat 106 with a fluid supply channel 109 located between the two. Associated with the exhaust port 110 is an exhaust valve seat 111 with a fluid channel located between the two. The valve 101 further includes a ball valve sealing member 120a located on a side of the supply valve seat 106 that is distal from the solenoid 150 that it is coupled with, and a separate exhaust valve sealing member 120b located on a side of both the supply valve seat 106 and the exhaust valve seat 111 that is proximal to the solenoid 150 that it is coupled with.

The supply valve seat 106 further comprises a supply valve seat orifice 107 and the exhaust valve seat 111 further comprises an exhaust valve seat orifice 112. The valve 101 may also include a flow diverter 127 disposed in a fluid passage between the ball valve sealing member 120a and the exhaust valve sealing member 120b, which may impart turbulent flow to fluid in the fluid passage to improve valve response stability at low control pressure and/or provide support to a distal end of the armature pin 137 adjacent the ball valve sealing member 120a. The flow diverter 127 also includes a flow diverter passage 128. Each of the supply valve seat orifice 107, the exhaust valve seat orifice 112, and the flow diverter passage 128 are aligned with a central longitudinal axis of the fluid control valve assembly 180 such that the armature pin 135, or the distal end of the armature pin 137, can pass through.

The fluid control valve assembly 100 includes a solenoid 150 portion, which in the embodiment illustrated in FIG. 1 is a push-type solenoid 150. In this instance, the push-type solenoid actuates towards the hydraulic valve portion, opposing a hydraulic force. In contrast, a pull-type solenoid actuates away from and in conjunction with a hydraulic valve portion and opposes a spring force. The solenoid 150 itself includes at least a solenoid housing case 155, a solenoid coil 162, an armature 140 movable in response to electric current applied to the solenoid coil 162, the armature pin 135 disposed between the armature 140 and the ball valve sealing member 120a, a tubular flux sleeve 160 radially surrounding at least a portion of the armature 140, a bobbin 157 having bobbin end flanges 158, and a pole piece 156. The solenoid further includes a damping T 170 movably associated with the armature pin 135 to reduce or dampen pressure oscillations, and a spring form retainer 166 typically calibrated to exert a specific spring force with an associated compression spring 167. These two components work in opposition to the resilient member 165, which the armature 140 must work against in order to actuate the ball valve sealing member 120a and the exhaust valve sealing member 120b.

In the fluid control valve assembly 100 illustrated in FIG. 1, the solenoid 150 is a push-type solenoid, meaning that the armature 140 is positioned within the solenoid such that in the energized state the armature 140 will move in the direction towards the valve 101. Conversely, in the non-energized state the armature 140 is maximally positioned to the right, directed away from the valve 101. Because of the position of the ball valve sealing member 120a relative to the supply valve seat 106, and the position of the other valve sealing member relative to the exhaust valve seat 107, as well as the configuration of the supply port 105, exhaust port 110, and control port 115, the valve illustrated in FIG. 1 is a NL valve as described in the foregoing. In the non-energized state fluid that enters the supply port 105 is prevented from passing the supply valve seat 106. Further any fluid that is present in the control port 115 or associated channels may flow towards the exhaust port 110 and exit the fluid control valve assembly 100 altogether. Accordingly, the fluid pressure sensed from the control port 115 is low and may approach zero.

In the energized state, the armature 140 of the fluid control valve assembly embodiment 100 is pushed towards the valve 101 such that the ball valve sealing member 120a is pushed off of the supply valve seat 106. Fluid that enters the supply port 105 may then flow towards the control port 115. Accordingly, the fluid pressure sensed from the control port is high. In the energized state, the armature 140 also pushes towards the valve 101 such that the exhaust valve sealing member 120b is pressed towards the exhaust valve seat 111. Fluid from the control port 115 may then be blocked from exiting the exhaust port 110 if the exhaust valve sealing member 120b is fully pressed on the exhaust valve seat 111.

In a state where the solenoid 150 is partially energized, wherein both the supply valve seat 106 and the exhaust valve seat 111 are both opened, fluid will flow

As described in the foregoing, in order to switch the pressure-current relationship of the NL valve embodied in FIG. 1, the solenoid 150 itself would have to be changed from the push-type solenoid 150 to a pull-type solenoid (not shown). In this instance, in the non-energized state the armature 140 would be maximally positioned to the left, closest to the valve 101. Because of the position of the ball valve sealing member 120a relative to the supply valve seat 106, and the exhaust valve sealing member 120b relative to the exhaust valve seat 107, as well as the configuration of the supply port 105, exhaust port 110, and control port 115, the valve 101 would effectively become a NH valve when associated with a pull-type solenoid as described in the foregoing. That is, in the non-energized state, the ball valve sealing member 120a would be off of the supply valve seat 106 and fluid that enters the supply port may then flow towards the control port 115. In this instance, the exhaust valve sealing member 120b may be pressing on the exhaust valve seat 111 such that fluid would be prevented from flowing to the exhaust port 110. Accordingly, the fluid pressure sensed from the control port in the non-energized state would be high.

In the energized state, the armature 140 of the fluid control valve assembly embodiment having a pull-type solenoid would be pushed away from the valve 101 and towards the right such that the ball valve sealing member 120a is sealed on the supply valve seat 106 and the exhaust valve sealing member 120b is pulled off of its exhaust valve seat 111. That is, in the energized state fluid that enters the supply port 105 is prevented from passing the supply valve seat 106. Further any fluid that is present in the control port 115 or associated channels may flow towards the exhaust port 110 and exit the fluid control valve assembly having a pull-type solenoid altogether. Accordingly, the fluid pressure sensed from the control port 115 is low and may approach zero.

As described in the foregoing, solenoids are often specifically designed to be incorporated into a specific housing; therefore, switching one solenoid component in exchange for another may present complications or additional costs. As illustrated and described herein, the valve of the present invention allows for a change in the pressure-current relationship of a valve assembly by changing the valve itself while keeping the already existing solenoid.

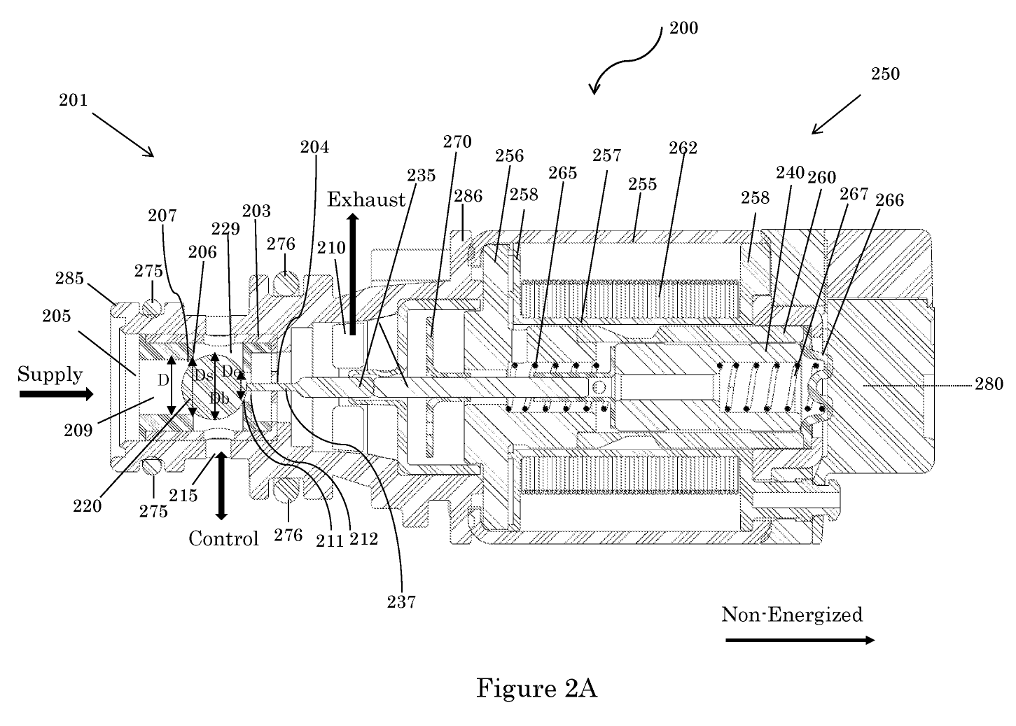

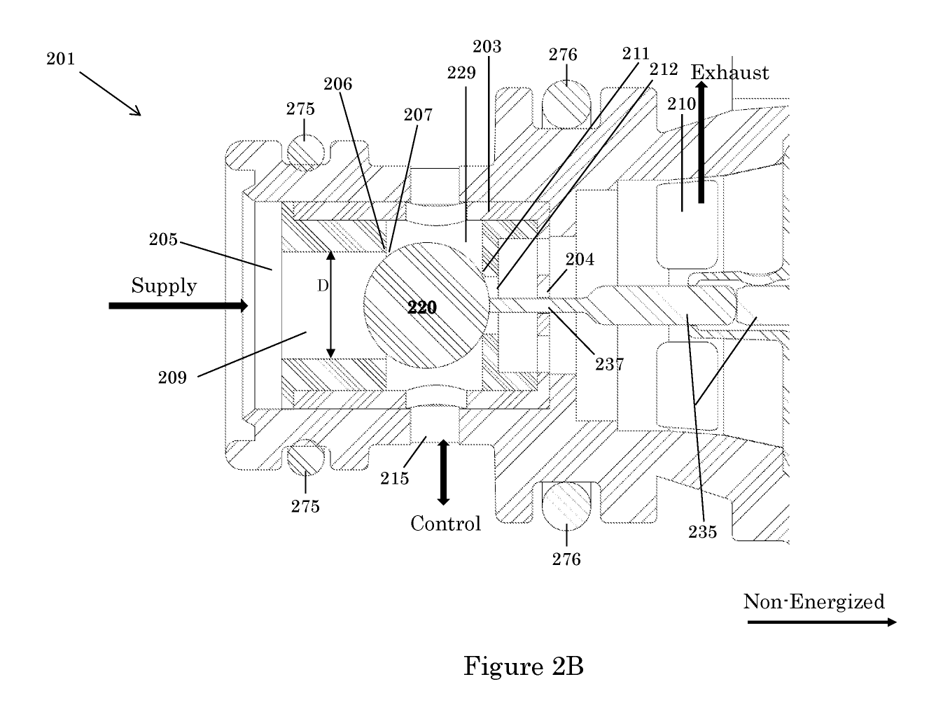

FIG. 2A illustrates a cross-sectional view of a fluid control valve assembly 200 in accordance with an embodiment of the present invention in the non-energized state. The fluid control valve assembly 200 includes a solenoid 250 and a valve 201 having a valve body 202 including at least three ports; a supply port 205, an exhaust port 210, and a control port 215.

In a preferred embodiment, the supply port 205 and corresponding fluid supply channel 209 are aligned with a central longitudinal axis of the fluid control valve assembly 280. In a preferred embodiment, the central longitudinal axis of the fluid supply channel 209 is collinear with the central longitudinal axis of the fluid control valve assembly 280. In a preferred embodiment, the control port is perpendicular to the central longitudinal axis of the fluid control valve assembly 280. In an embodiment, the control port 215 may be located in a portion of the valve 201 located between O-rings 275 and 276. In another preferred embodiment, the exhaust port is also perpendicular to the central longitudinal axis of the fluid control valve assembly 280.

In an embodiment, the control port 215 may be located at the second end 285 of the valve 201 and the supply port 205 may be located in the middle portion of the valve 201 between the O-rings 275, 276. In an embodiment, the control port 215 is collinear with the central longitudinal axis of the fluid control valve assembly 280. In a preferred embodiment the supply port 205 is perpendicular to the central longitudinal axis of the fluid control valve assembly 280. In a preferred embodiment, the exhaust port is also perpendicular to the central longitudinal axis of the fluid control valve assembly 280.

Associated with the supply port 205 is a supply valve seat 206 with the fluid supply channel 209 located between the two. The supply valve seat may be formed from the interior edges of a top surface 214 of the walls that form the fluid supply channel 209. In a preferred embodiment, the fluid supply channel 209 is cylindrically shaped. Associated with the exhaust port 210 is an exhaust valve seat 211 with an exhaust fluid channel 213 located between the two.

The supply valve seat 206 further comprises a supply valve seat orifice 207. The supply valve seat orifice 207 is preferably shaped and sized to meet the interior edges of the fluid supply channel 209. In a preferred embodiment the supply valve seat orifice 207 has a diameter Dₛ that is identical to the diameter D of the fluid supply channel 209.

The exhaust valve seat 211 further comprises an exhaust valve seat orifice 212. In a preferred embodiment, the exhaust valve seat orifice 212 has a diameter Dₑ. In a preferred embodiment, the diameter Dₛ of the supply valve seat orifice 207 is greater than the diameter Dₑ the exhaust valve seat orifice 212.

In the embodiment where the diameter Dₛ of the supply valve seat orifice 207 is greater than the diameter Dₑ of the exhaust valve seat orifice 212, the flow of fluid through the valve from the supply port 205 to the control port 215 is increased, which may provide for a faster response time to a control circuit. Notably, the size of the diameter Dₛ of the supply valve seat orifice 207 may also determine the hydraulic force required to be overcome by the magnetic force from the solenoid 250.

With regard to the diameter Dₑ of the exhaust valve seat orifice 212, the diameter of the distal end of the armature pin 237 that protrudes into the exhaust seat area is sufficiently smaller than the diameter Dₑ of the exhaust valve seat orifice 212 such that flow restriction remains between a valve sealing member 220 and the exhaust valve seat 211, and not between the exhaust valve seat 211 and the distal end of the armature pin 237.

The valve 201 further includes the valve sealing member 220 located in an interior chamber 229 between the supply valve seat 206 and the exhaust valve seat 211. In an embodiment, the interior chamber 229 may be bordered on its proximal end by the exhaust valve seat 211. In an embodiment, the interior chamber may be bordered on its distal end by the supply valve seat 206. In an embodiment, the width of the interior chamber 229 is greater than the width of the fluid supply channel 209. In a preferred embodiment, the width of the interior chamber 229 is greater than the diameter Dₛ of the supply valve seat orifice 207 and the diameter Dₑ of the exhaust valve seat orifice 212.

In a preferred embodiment, the valve sealing member 220 is a ball. The ball valve sealing member 220 seals on the diameter formed by the respective valve seat edges. In this embodiment, the diameter D_{b} of the ball valve sealing member 220 is greater than the width of the fluid supply channel 209. In an embodiment where the fluid supply channel 209 is cylindrical, the diameter D_{b} of the ball valve sealing member 220 may be greater than the diameter D of the fluid supply channel 209. In a preferred embodiment, the diameter D_{b} of the ball valve sealing member 220 is greater than the diameter Dₑ of the exhaust valve seat orifice 212. In a more preferred embodiment, the diameter D_{b} of the ball valve sealing member 220 is greater than 4 mm.

The valve body 202 may further include an inner housing 203. In an embodiment, the inner housing 203 may surround both the both the supply valve seat 206 and the exhaust valve seat 211. The inner housing 203 also includes an inner housing orifice 204 located at an end proximal to the solenoid 250. In an embodiment, the inner housing orifice 204 provides stability to the distal end of the armature pin 237 through passage of the distal end of the armature pin 237 through an inner housing orifice 204.

In a preferred embodiment, each of the supply valve seat orifice 207, the exhaust valve seat orifice 212, and the inner housing orifice 204 are aligned with the central longitudinal axis of the fluid control valve assembly 280 such that the distal end of the armature pin 237 can pass through at least the inner housing orifice 204.

The fluid control valve assembly 200 includes a solenoid 250 portion, which in the embodiment illustrated in FIG. 2A is a push-type solenoid 250. The solenoid 250 itself includes at least a solenoid housing case 255, a solenoid coil 262, an armature 240 movable in response to electric current applied to the solenoid coil 262, the armature pin 235 disposed between the armature 240 and the ball valve sealing member 220, a tubular flux sleeve 260 radially surrounding at least a portion of the armature 240, a bobbin 257 having bobbin end flanges 258, and a pole piece 256.

In an embodiment, the solenoid may further include a damping T 270 movably associated with the armature pin 235 to reduce or dampen pressure oscillations. In an embodiment, the solenoid 250 comprises an armature pin support body 236, which supports a more proximal portion of the armature pin 235 relative to the inner housing orifice 204, which supports the distal end of the armature pin 237. In an embodiment, the armature pin 235 may be composed of two pieces.

The solenoid may further include a spring form retainer 266 typically calibrated to exert a specific spring force along with an associated compression spring 267. These two components work in opposition to the resilient member 265, which comprises a given spring force that the armature 240 must work against in order to actuate the ball valve sealing member 220.

In the fluid control valve assembly 200 illustrated in FIG. 2A, the solenoid 250 is a push-type solenoid, meaning that the armature 240 is positioned within the solenoid such that in the energized state the armature 240 will move in the direction towards the valve 201, while in the non-energized state the armature 240 is maximally positioned to the right, directed away from the valve 201 and forming a seal with the exhaust valve seat 211 as shown in FIG. 2A. Because of the position of the ball valve sealing member 220 relative to the supply valve seat 206 and exhaust valve seat 207, as well as the configuration of the supply port 205, exhaust port 210, and control port 215, the fluid control valve assembly 200 illustrated in FIG. 2A is a NH valve as described in the foregoing.

FIG. 2B is an enlarged view of the valve body 202 of FIG. 2A illustrating the relationship of the valve sealing member 220 relative to the supply valve seat 206 and the exhaust valve seat 211 in the non-energized state. In the non-energized state, the valve sealing member 220 is pressed up against the exhaust valve seat 211 closing flow of fluid from the supply port 205 or the control port 215 to the exhaust port 210. Because the valve sealing member 220 is not pressed up against the supply valve seat 206, a gap between the valve sealing member 220 and the supply valve seat 206 exists such that when fluid enters the supply port 205 it may flow towards the control port 215. Accordingly, the fluid pressure sensed from the control port 215 is high.

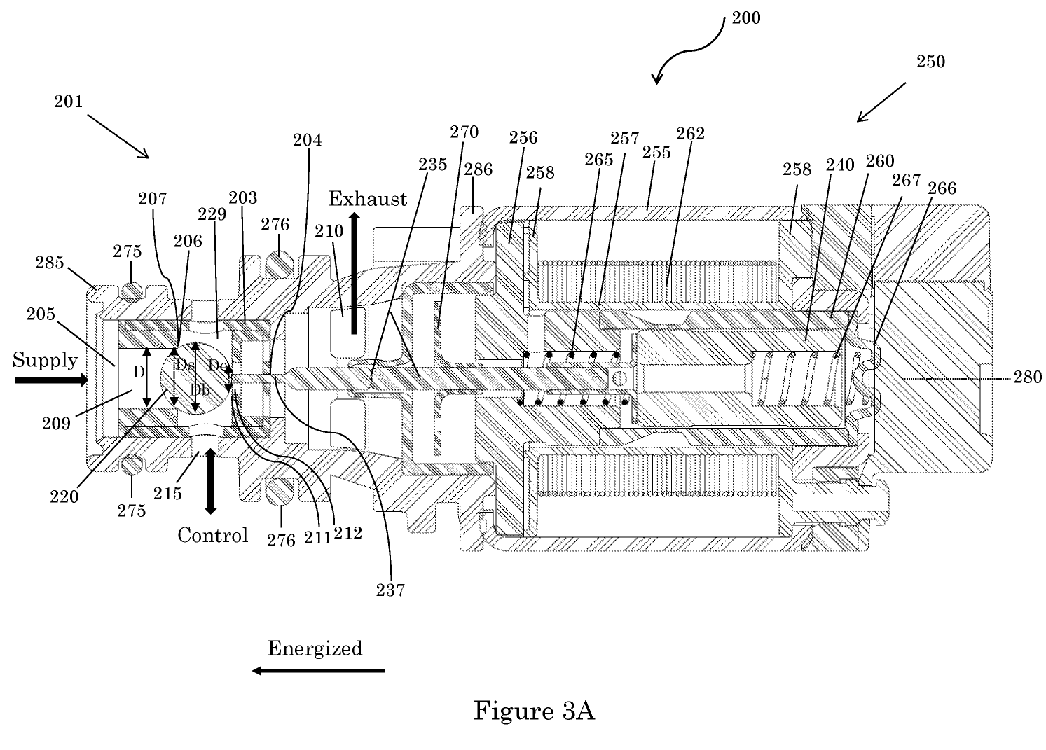

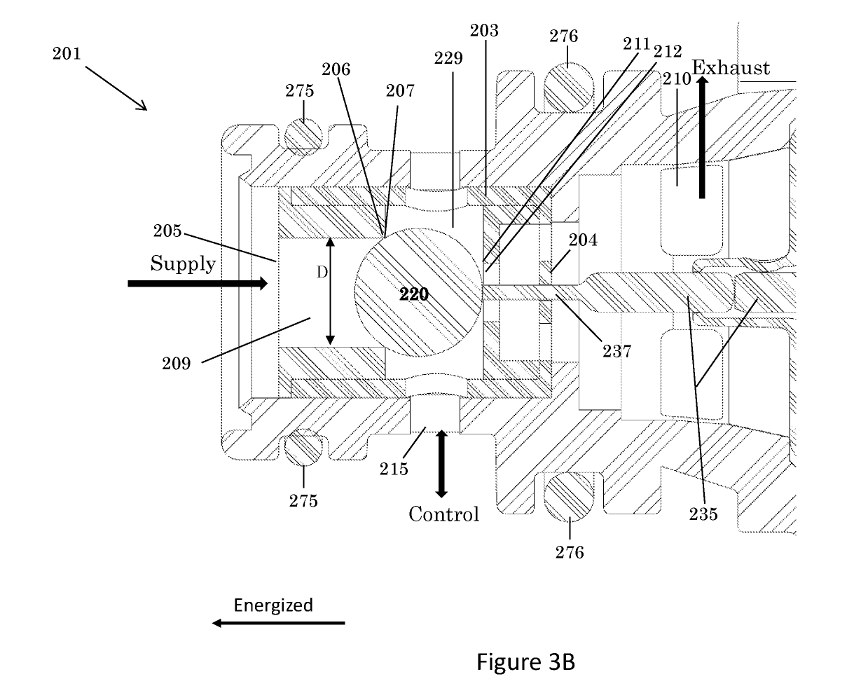

FIG. 3A illustrates the fluid control valve assembly 200 of FIG. 2A in the energized state. In the energized state, the armature 240 of the fluid control valve assembly embodiment 200 is pushed towards the valve 201 such that the valve sealing member 220 is pressed up against the supply valve seat 106. In the energized state fluid that enters the supply port 205 is prevented from passing the supply valve seat 206. Because the valve sealing member 220 is not pressed up against the exhaust valve seat 211, a gap between the valve sealing member 220 and the exhaust valve seat 211 exists such that when fluid that is present in the control port 215 or associated channels may flow towards the exhaust port 210 and exit the fluid control valve assembly 200 altogether. Accordingly, the fluid pressure sensed from the control port is low and may approach zero.

FIG. 3B is an enlarged view of the valve body 202 of FIG. 3A illustrating the relationship of the valve sealing member 220 relative to the supply valve seat 206 and the exhaust valve seat 211 in the energized state. In the energized state, the valve sealing member 220 may be pressed up against the supply valve seat 206 closing flow of fluid from the supply port 205. Fluid may flow from the control port 215 towards the exhaust port 210. Accordingly, the fluid pressure sensed from the control port 215 is low.

In an embodiment, the fluid control valve assembly 200 of FIG. 2A is partially energized such that the valve sealing member 220 is located between both the supply valve seat 206 and the exhaust valve seat 211 such that it does not form a seal with either valve seat 206, 211. In this embodiment, fluid may flow from the supply port 205 to the control port 215 or the exhaust port 210. In this embodiment, fluid may also flow from the control port 215 to the exhaust port 210. The pressure sensed at the control port 215 in this embodiment is dynamic in that pressure sensed at the control port 215 will start to decrease as the exhaust valve seat 211 is opened more and the supply valve seat 206 is closed more.

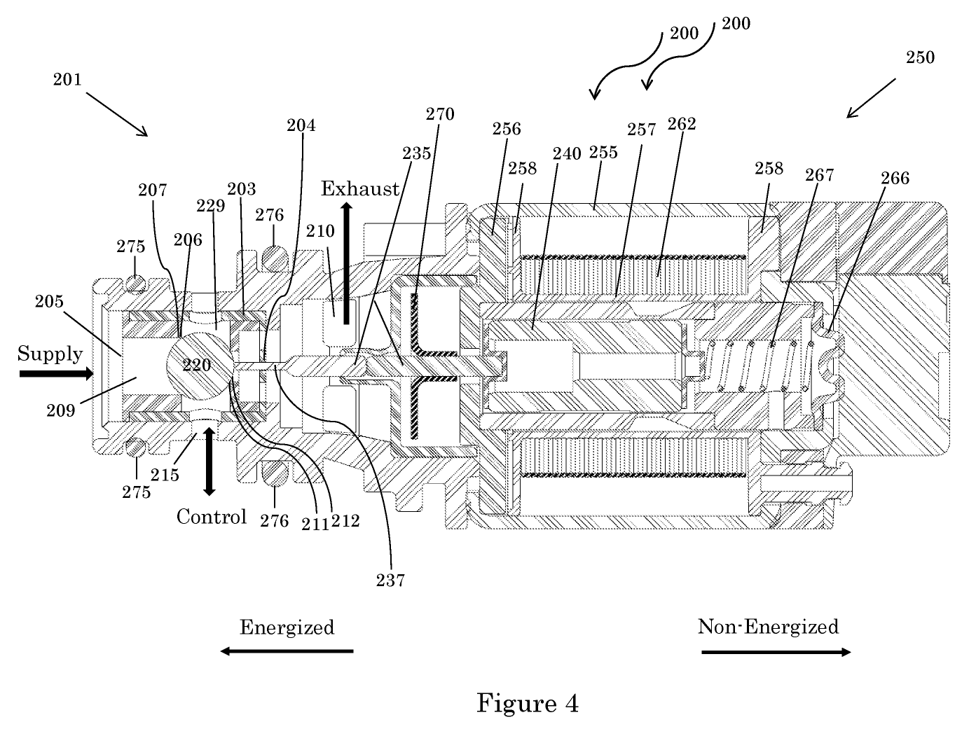

In another embodiment, the valve 201 of the present invention may be preferably coupled with a pull-type solenoid 250, as illustrated in FIG. 4. In this embodiment, the valve 201 may still be located on a same side of a solenoid valve assembly 200. However, the pressure-current relationship would dictate that the same inventive valve 201 become a NL valve. In this embodiment, in the non-energized state, the armature pin 235 would be fully positioned to the left, closest to the valve 201. In this state, the valve sealing member 220 would be pressed up against the supply valve seat 205 such that fluid that enters the supply port 205 is prevented from passing the supply valve seat 206. Further any fluid that is present in the control port 215 or associated channels may flow towards the exhaust port 210 and exit the fluid control valve assembly 200 altogether. Accordingly, the fluid pressure sensed from the control port 215 is low and may approach zero in the non-energized state, fitting the description of a NL valve.

Conversely, in the energized state the armature 240 of the solenoid 250 would be pulled to the right, away from the valve 201. In the energized state, the valve sealing member 220 is pressed up against the exhaust valve seat 211 closing the flow of fluid from the supply port 205, or the control port 215, to the exhaust port 210. Fluid that enters the supply port 205 may flow towards the control port 215. Accordingly, the fluid pressure sensed from the control port is high in the energized state, fitting the description of a NL valve.

In an embodiment, the solenoid 250 is partially energized such that the valve sealing member 220 is located between both the supply valve seat 206 and the exhaust valve seat 211 such that it does not form a seal with either valve seat 206, 211. In this embodiment, fluid may flow from the supply port 205 to the control port 215 or the exhaust port 210. In this embodiment, fluid may also flow from the control port 215 to the exhaust port 210. In an embodiment, the diameter of the exhaust seat orifice 212 is small, relative to size of the fluid supply channel 209 for example. This allows for the pressure sealing the exhaust valve seat 211 to be low. This lower pressure at the exhaust valve seat 211 helps to facilitate a smooth lift-off of the valve sealing element 220 from the exhaust valve seat 211 because the initial solenoid force is low at low current, but then eventually increases.

Those of ordinary skill in the art may recognize that many modifications and variations of the above may be implemented without departing from the spirit or scope of the following claims For example, although reference is made to a hydraulic valve with fluid flow, other matter such pressurized gas may benefit from the disclosed valve and valve assembly.

What is claimed:

1. A fluid control valve comprising:
a valve body including a supply port, a control port, an exhaust port, wherein the supply port is in selective communication with the control port, and the exhaust port is in selective communication with the control port;
a valve sealing member;
a supply valve seat comprising a supply valve seat orifice having a first diameter; and
an exhaust valve seat comprising an exhaust valve seat orifice having a second diameter, wherein
the valve sealing member is located between the supply valve seat and the exhaust valve seat, supported for linear displacement between at least a first valve position and a second valve position, wherein
in the first valve position the valve sealing member is pressed against the exhaust valve seat such that the supply port is in fluid communication with the control port and fluid pressure at the control port is high, and
in the second valve position the valve sealing member is pressed against the supply valve seat such that the control port is in fluid communication with the exhaust port and fluid pressure at the control port is low.

2. The fluid control valve of claim 1, wherein in the first valve position the valve sealing member closes the exhaust port to fluid communication with the supply port and the control port, and in the second valve position the valve sealing member closes the supply port to fluid communication with the control port and the exhaust port.

3. The fluid control valve of claim 1, wherein the first diameter of the supply valve seat orifice is greater than the second diameter of the exhaust valve seat orifice.

4. The fluid control valve of claim 1, wherein the exhaust valve seat is positioned across an interior chamber from the supply valve seat and the valve sealing member is located at least partially within the interior chamber of the valve body between the supply valve seat and the exhaust valve seat.

5. The fluid control valve of claim 1, wherein the valve sealing member is a ball having a third diameter.

6. The fluid control valve of claim 5, wherein the third diameter of the ball is greater than the second diameter of the exhaust valve seat orifice and the first diameter of the supply valve seat orifice.

7. The fluid control valve of claim 1, wherein:
the valve is in the first valve position when operatively coupled to a push-type solenoid in the non-energized state, and
the valve is in the second valve position when operatively coupled to the push-type solenoid in the energized state.

8. The fluid control valve of claim 1, wherein:
the valve is in the second valve position when operatively coupled to a pull-type solenoid in the non-energized state, and
the valve is in the first valve position when operatively coupled to the pull-type solenoid in the energized state.

9. The fluid control valve of claim 1, wherein the valve body further comprises an inner housing, wherein
the inner housing includes an inner housing orifice that is aligned with the supply valve seat orifice and the exhaust valve seat orifice,
the inner housing orifice is between the exhaust valve seat and a second end of the valve, and
the inner housing orifice is configured to accommodate an armature pin of an actuator.

10. The fluid control valve of claim 1, wherein a first end of the valve is configured for fluid tight coupling to a hydraulic system benefitting from the valve and a second end of the valve is configured for coupling with a solenoid.

11. A fluid control valve assembly comprising:
a valve body including a supply port, a control port, an exhaust port, wherein the supply port is in selective communication with the control port, and the exhaust port is in selective communication with the control port;
a valve sealing member;
a supply valve seat comprising a supply valve seat orifice having a first diameter;
an exhaust valve seat comprising an exhaust valve seat orifice having a second diameter; and
an actuator comprising an armature operatively coupled to the valve sealing member and supported for linear displacement between at least a first valve position and a second valve position, wherein
the valve sealing member is located between the supply valve seat and the exhaust valve seat, supported for linear displacement between at least the first valve position and the second valve position, wherein
in the first valve position the valve sealing member is pressed against the exhaust valve seat such that the supply port is in fluid communication with the control port and fluid pressure at the control port is high, and
in the second valve position the valve sealing member is pressed against the supply valve seat such that the control port is in fluid communication with the exhaust port and fluid pressure at the control port is low.

12. The fluid control valve assembly of claim 11, wherein the actuator is a solenoid comprising a coil, wherein the armature is linearly displaced in response to an electrical current applied to the coil.

13. The fluid control valve assembly of claim 12, wherein the solenoid is a push-type solenoid such that,
in the non-energized state, the valve is in the first valve position and fluid pressure at the control port is high, and
in the energized state, the valve is in the second valve position and fluid pressure at the control port is low.

14. The fluid control valve assembly of claim 12, wherein the solenoid is a pull-type solenoid such that,
in the non-energized state, the valve is in the second valve position and fluid pressure at the control port is low, and
in the energized state, the valve is in the first valve position and fluid pressure at the control port is high.

15. The fluid control valve assembly of claim 11, wherein the valve sealing member is a ball having a third diameter

16. The fluid control valve assembly of claim 15, wherein the first diameter of the supply valve seat orifice is greater than the second diameter of the exhaust valve seat orifice, and
the third diameter of the ball is greater than both the second diameter of the exhaust valve seat orifice and the first diameter of the supply valve seat orifice.

17. The fluid control valve assembly of claim 11, wherein the armature is coupled to the valve sealing member via an armature pin directly linked to the armature and abutting a portion of the valve sealing member.

18. The fluid control valve of claim 17, wherein the valve body further comprises an inner housing, wherein
the inner housing includes an inner housing orifice that is aligned with the supply valve seat orifice and the exhaust valve seat orifice,
the inner housing orifice is between the exhaust valve seat and a second end of the valve, and
the inner housing orifice is configured to accommodate the armature pin.

19. The fluid control valve of claim 11 wherein the exhaust valve seat is positioned across an interior chamber from the supply valve seat and the valve sealing member is located at least partially within the interior chamber of the valve body between the supply valve seat and the exhaust valve seat.
